(19) United States
(12) Patent Application Publication
(10) Pub. No.: US 2025/0380130 A1
(43) Pub. Date: Dec. 11, 2025

(54) SYSTEM AND METHOD FOR A PHYSICAL LAYER SECURITY SCHEME USING A MACHINELEARNING-INTEGRATED SHARED SECRET KEY SCHEME

(71) Applicant: Board of Regents, The University of Texas System, Austin, TX (US)

(72) Inventors: Israt Ara, San Antonio, TX (US); Brian Kelley, San Antonio, TX (US)

(21) Appl. No.: 19/236,814

(22) Filed: Jun. 12, 2025

Related U.S. Application Data
(60) Provisional application No. 63/658,408, filed on Jun. 10, 2024.

(51) Int. Cl. H04W 12/037; H04B 7/0456; H04L 5/00

(52) U.S. Cl. CPC H04W 12/037; H04B 7/0456; H04L 5/0048

(57) ABSTRACT

A computer-implemented Alamouti shared secret key physical layer security method enables secure communication between first and second network nodes in a communications network. Each node, equipped with M antenna elements, exchanges pilot signals to reconstruct channels via singular value decomposition. The first node transmits reference signals, rotated by a random unitary matrix, and their complex conjugates across time slots or frequency sub-channels. Both nodes generate secret keys, divide them into sequences, and encode them using a precoding matrix and universal codebook indices. Encoded sequences are transmitted, received, and decoded through singular value decomposition or machine learning to estimate the counterpart's secret key. Concatenating estimated and local secret keys forms a whole secret key, used for ongoing secure communication. The method operates over Open Radio Access Network (O-RAN) E2 interfaces, supporting centralized or distributed units, ensuring robust physical layer security.

### RELATED APPLICATIONS

This application claims priority to U.S. Provisional Application 63/658,408 filed Jun. 10, 2024 which is incorporated herein by reference in its entirety.

### FIELD

The present disclosure relates generally to communication network security schemes, and in particular to a system and method for a physical layer security scheme using a machine learning-integrated shared secret key scheme.

### BACKGROUND

Space-time coding (STC) or the dual concept Space-frequency coding (SFC) is a conventional technique commonly used in wireless communications to improve the reliability of data transmission over multiple antennas in a multi-path fading environment. The fundamental idea behind space-time (space-frequency) coding is to take advantage of both spatial and temporal (frequency subchannel) dimensions, utilizing multiple transmit and receive antennas to combat the effects of fading and enhance overall system performance. For the purposes of this discussion we refer to the code whether across space frequency or space time as Space-time coding. Space-time coding leverages multiple antennas at both the transmitter and the receiver to introduce spatial diversity. Each antenna can experience a different channel condition due to reflections, diffractions, and scattering in the wireless environment. The temporal (frequency) dimension is incorporated by transmitting the same or different symbols over multiple time slots (frequency subchannels). This introduces diversity over time (frequency), allowing the system to combat variations in the channel conditions. Space-time codes use specific redundancy encoding scheme across the antenna array to determine how symbols are transmitted from different antennas over time (frequency). These redundancy encoding schemes are designed to provide signal orthogonality, power gains, and diversity gain, ensuring that the transmitted signals as processed after the received signal detector do not interfere with each other

Alamouti coding is a specific well-known space-time coding technique that employs a simple 2×2 MIMO (Multiple-Input Multiple-Output) system with two transmit antennas and two receive antennas. The dual space-frequency coding technique represents a straightforward extension. The Alamouti and its dual coding technique involves transmitting pairs of symbols over two consecutive time slots (two nearly adjacent frequency sub-channels) and apply a specific coding scheme to achieve orthogonality. MIMO systems including those employing space-time coding, are widely used in modern wireless communication standards such as 4G LTE, 5G NR, and emerging 6G proposals. MIMO systems contribute to increased data rates, better coverage, and improved spectral efficiency.

### SUMMARY

The present invention provides a computer-implemented method and communication network node for implementing an Alamouti shared secret key physical layer security method between first and second network nodes in a communications network. The method leverages multiple-input multiple-output (MIMO) antenna systems and the Alamouti space-time coding scheme to establish a secure shared secret key. The process involves transmitting and receiving pilot signals between the first and second network nodes, each equipped with M antenna elements, to estimate communication channels using singular value decomposition (SVD). The first network node transmits reference signals, including their complex conjugates, rotated by a random unitary matrix across different time slots or frequency sub-channels. Both nodes generate their respective secret keys, divide them into sequences, and encode these sequences using a precoding matrix and indices from a universal codebook. The encoded sequences are exchanged, received, and processed using SVD to estimate the other node's secret key. The estimated and locally generated secret keys are concatenated to form a whole secret key, which is used for secure communication between the nodes. In some embodiments, the method operates within security applications over Open Radio Access Network (O-RAN) E2 interfaces, including in O-RAN Centralized Units or Distributed Units. An alternative embodiment incorporates machine learning models to determine precoding matrix indices (PMI) for decoding the secret key sequences, enhancing the efficiency of key estimation. The invention provides a robust physical layer security mechanism suitable for modern wireless communication systems, ensuring secure key exchange with resilience against eavesdropping.

### BRIEF DESCRIPTION OF THE DRAWINGS

FIG. 1 is a message diagram of an exemplary embodiment of a shared key-based Physical Layer Security scheme according to the teachings of the present disclosure;

FIG. 2 is a diagram illustrating the Stage 0 signaling procedure, with reference signals selected across M frequency subchannels f₁, f₂, . . . fₘ and G is drawn from the set of random unitary operators in Stage 0, of an exemplary embodiment of a shared key-based Physical Layer Security scheme according to the teachings of the present disclosure;

FIG. 3A-3B are BER performance diagrams of an exemplary embodiment of a shared key-based Physical Layer Security scheme according to the teachings of the present disclosure; (A) codebook size=64, (B) codebook size=256 using multi-array antenna in Uplink and Downlink transmission case scenario. Higher bit-codebook can help achieve higher spectral efficiency.

FIG. 4A-4B is a simplified diagram of an exemplary embodiment of a transmission sequence of Alamouti-Space Time Coded or Space-Frequency Coded shared key-based Physical Layer Security Kernel scheme according to the teachings of the present disclosure; (A) M, a small integer, is the antenna array size parameter. T is the symbol period. The value nT is the time of the earlier symbol. The value (n+m)T is the time of the later arriving symbol, where m is a small integer. (B) M, a small integer, is the antenna array size parameter. The parameter δ is the subchannel spacing in Hz. The value kδ is the frequency of the first symbol. The value (k+m)δ is the frequency of the second symbol where m is a small integer (m=−1 or m=1).

FIG. 5 is a simplified diagram of an exemplary embodiment of an Alamouti-based Space-Time Coded (or Space-Frequency Coded) Physical Layer Security scheme, wherein two random unitary operators can now be transmitted via two antenna sites in one time period (or frequency sub-carrier) when their conjugates are being transmitted in next time period (or frequency sub-carrier), according to the teachings of the present disclosure;

FIG. 6 is a simplified diagram of an exemplary embodiment of a distributed O-RAN for 6G with a Physical Layer Security scheme according to the teachings of the present disclosure;

FIG. 7 is a table of the channels between the transmit and receive antenna sites of an exemplary embodiment of an Alamouti-based Space-Time (Frequency) Coded scheme according to the teachings of the present disclosure;

FIGS. 8A-8B and 9A-9B shows equations for the exemplary mathematical operations in an embodiment of an Alamouti-based Space-Time Coding and Space-Frequency Coding scheme according to the teachings of the present disclosure;

FIGS. 8A-9A shows equations for the exemplary mathematical operations in an embodiment of an Alamouti-based Space-Time Coding scheme according to the teachings of the present disclosure; In FIGS. 8A-9A m is selected as 1 but could be any time offset adjacent to the symbol according to the teachings of the patent disclosure.

FIG. 8B-9B shows equations for the exemplary mathematical operations in an embodiment of an Alamouti-based Space-Frequency Coding scheme, where m is a small integer and could be any positive or negative frequency offset (e.g., m=−1 or m=1) adjacent to k, the parameter δ is the subchannel spacing in Hz, according to the teachings of the present disclosure;

FIG. 10 shows the channel super-matrices between the transmit and receive antenna sites of an exemplary embodiment of an Alamouti-based Space-Time (Frequency) Coded Physical Layer Security scheme according to the teachings of the present disclosure;

FIG. 11 is a table of the channels between the transmit and receive antenna sites of an exemplary embodiment of an Alamouti-based Space-Time (Frequency) Coded Physical Layer Security scheme according to the teachings of the present disclosure;

FIG. 12A-12B are a tables of transmission sequence between the transmit and receive antenna sites of an exemplary embodiment of an Alamouti-based Space-Time Coded and Space-Frequency Coded Physical Layer Security scheme according to the teachings of the present disclosure;

FIG. 12A is a table of encoded information transmission sequence between the transmit and receive antenna sites of an exemplary embodiment of an Alamouti-based Space-Time Coded Physical Layer Security scheme according to the teachings of the present disclosure; In FIG. 12A m is selected as 1 but could be any time offset adjacent to the symbol according to the teachings of the patent disclosure.

FIG. 12B is a table of encoded information transmission sequence between the transmit and receive antenna sites of an exemplary embodiment of an Alamouti-based Space-Frequency Coded Physical Layer Security scheme according to the teachings of the present disclosure; In FIG. 12B m is a small integer and could be any positive or negative frequency offset (e.g., m=−1 or m=1) adjacent to k, the parameter δ is the subchannel spacing in Hz.

FIGS. 13-24 show equations for the exemplary mathematical operations in an embodiment of an Alamouti-based Space-Time (Frequency) Coded Physical Layer Security scheme according to the teachings of the present disclosure;

FIG. 25 is a simplified message flow diagram of an exemplary embodiment of an E2 set up procedure of an Alamouti-based Space-Time (Frequency) Coded Physical Layer Security scheme in O-RAN according to the teachings of the present disclosure;

FIG. 26 is a simplified message flow diagram of an exemplary embodiment of an E2 node communication procedure of an Alamouti-based Space-Time (Frequency) Coded Physical Layer Security scheme, between containerized micro-application, s-App in O-CU/O-DU and O-DU/O-RU (based on category A or category B O-RU used) in O-RAN according to the teachings of the present disclosure;

FIG. 27 is an illustration of an exemplary embodiment of an AI/ML (Artificial Intelligence/Machine Learning) based Physical Layer Security procedure in O-RAN according to the teachings of the present disclosure;

FIG. 28 is an illustration of an exemplary embodiment of the adopted ML model (Deep Neural Network) for decoding stage in Physical Layer Security (demonstrated just Stage 1 tx and decoding for simplification purpose) procedure according to the teachings of the present disclosure; and

FIG. 29 is an illustration of an exemplary embodiment of ML-based decoding algorithm for space-time coded shared key-based PLS (Stage 1: Bob-to-Alice transmission) according to the teachings of the present disclosure.

FIG. 30A-30B is an illustration of an exemplary embodiment of performance comparison between space-time coded shared key-based PLS and conventional shared key-based PLS for a codebook size of 4 and antenna array size, M=2, in multiple environments (Hilly Terrain, Rural Area and Typical Urban) according to the teachings of the present disclosure. BER performance of STC PLS vs. non-STC shared key based PLS using a 2-bit codebook for (A) Bob-to-Alice (UL) and (B) Alice-to-Bob (DL) transmission

FIG. 31A-31B is an illustration of an exemplary embodiment of performance comparison between space-time coded shared key-based PLS and conventional shared key-based PLS for a codebook size of 16 and antenna array size, M=2, in multiple environments (Hilly Terrain, Rural Area and Typical Urban) according to the teachings of the present disclosure. BER performance of STC vs. non-STC shared key based PLS using a 4-bit codebook for (A) Bob-to-Alice uplink (UL) and (B) Alice-to-Bob downlink (DL) transmission, where M=2.

### DETAILED DESCRIPTION

The present disclosure describes the application of space-time (frequency) coding such as Alamouti-based diversity coding to physical layer security (PLS) as a native 6G communication operation mode. Because sixth generation (6G) networks with peak data rates at 1 Tbps will ubiquitously integrate with critical infrastructure (e.g., Internet of Things/IoT and Internet of Everything/IoE) enable omnipresent services, security performance is even more essential and vital. The present disclosure describes a 6G PLS framework that combines a Deep Neural Network with a shared key-based PLS scheme at the decoding stage to achieve higher security performance. In particular, the PLS scheme includes an application of the Alamouti Space-Time Coding (STC) or Space-Frequency Coding (SFC) over adjacent periods or nearly adjacent sub-channels within a shared key-based PLS scheme with 2M transmit and 2M receive antennas, including an operational overview of AI/ML-integrated (Artificial Intelligence/Machine Learning-integrated) PLS with shared key-agreement protocol in an Open Radio Access Network (O-RAN) architecture model. An analysis of the ML-based PLS shows that eavesdroppers cannot perfectly decode the secret information even under improved SNR (Signal to Noise Ratio) case scenarios, and legitimate receivers achieve nearly perfect secrecy even at lower SNR cases by adopting the AI/ML-based PLS model.

The International Telecommunication Union (ITU) Radio Communication Assembly agreed within the International Mobile Telecommunications (IMT-2030) framework on the technical objectives for 6G. Physical Layer Security (PLS) has been identified as a potential technology needed to ensure security and resilience, particularly for shared secret information exchanges between legitimate users within computer networks. Security algorithms deployed in Layer-1 (i.e., PHY layer) have a significant latency advantage over traditional security methods that apply security protocols at Layer-3 and Layer-4 of the Open System Interconnect (OSI) protocol stack. In shared key cryptography, shared key PLS enables secure, dynamic shared key refresh at Layer-1. In addition, PLS, with the help of proper coding to generate the shared secret information, exploits the random dynamics of wireless channels to guarantee message confidentiality. Also, shared key PLS primarily depends on the differences in the channel rather than SNR and cannot be overcome simply by placing the eavesdropper closer to the transmitter. Hence, shared key PLS methods are the research focus of this work. In addition, the approach can enhance the security performance of wireless networking for key sharing algorithms for the generic streaming of confidential information.

In the shared key and codebook-based PLS model with associated p-bit sequences, a universal codebook shared among the communication terminals contains a finite number, 2^{p}, of precoding matrices. Each precoding matrix in the codebook has an index, the Precoding Matrix Index (PMI). The secret information from legitimate transmitters and receivers maps to a precoding matrix. The PMI, in turn, maps to secret keys transmitted from legitimate information sources. Information concealment applies pseudo-random unitary matrix operators drawn from the set of complex numbers, C, within the PLS-PMI framework. The length of the secret key is pre-agreed between the transmitters and receivers. The codebook elements are formulated by applying an approach of minimizing the maximum correlation coefficient among the codebook elements.

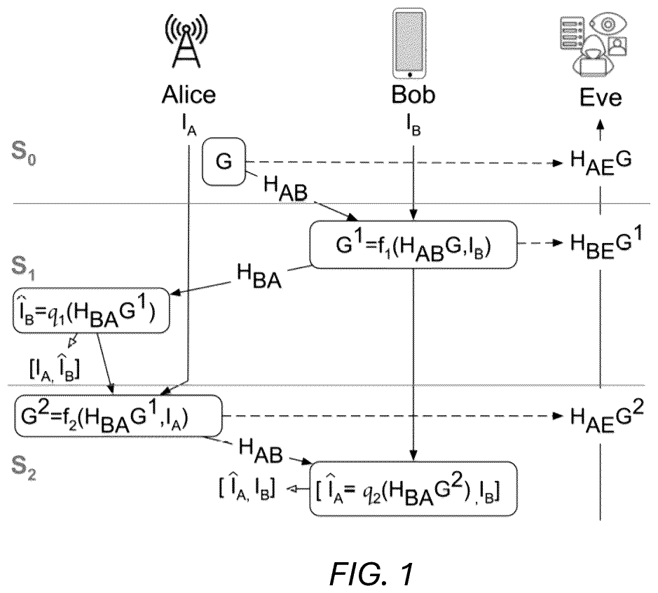

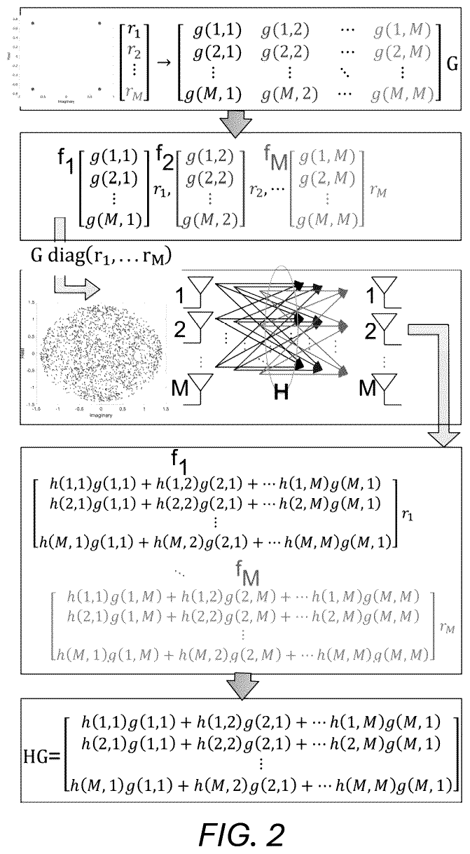

FIG. 1 represents a shared key based physical layer security model for 6G cellular consisting of three users: Alice denoted as the Radio Access Network (RAN), Bob, represented as the User Equipment (UE) and Eve, who passively eavesdrops on the secret bidirectional information exchange between Alice and Bob (the legitimate users). In FIG. 1, the Time Division Duplex (TDD) channel between Alice and Bob is denoted as H_{AB}, and the Bob to Alice channel is denoted as H_{BA}. Due to TDD reciprocity, H_{BA}=(H_{AB})^{T}. H_{AE} and H_{BE} denote the channel between Alice-Eve and Bob-Eve, respectively. The different stages of transmission are denoted as S₀, S₁ and S₂ in FIG. 1. In Stage 0, S₀, the legitimate transmitter, Alice, first sends out a reference signal for the legitimate receiver, Bob, to estimate the channel matrix H_{AB}, as illustrated in FIG. 1. Due to signal precoding with a random unitary operator, Alice's and Bob's air interface signal waveform is obscured and appears indistinguishable from noise to eavesdroppers. Indirectly, Alice and Bob extract the LHS and RHS singular matrices from performing Singular Value Decomposition (SVD) of the received signal in the next stages of transmission (S₁ and S₂), which can be denoted as GH (e.g., H=H_{AB} for Alice-to-Bob signaling). The signaling procedure of the reference signals rotated by the random unitary matrix, G, is illustrated in FIG. 2. Signal structures are defined via matrix signal format rather than reference signal format. The precoder from Alice-to-Bob at stage 0 (S₀), Bob-to-Alice at stage 1 (S₁), and Alice-to-Bob at state 2 (S₂), correspond to G, G¹, G². Bob's secret information (e.g., “secret key”) in S₁, I_{B} requires encoding using a codebook. Bob sends an encoded I_{B} to Alice over the channel. Alice's estimated version of Bob's secret key is Î_{B}. Concatenating I_{A} and Î_{B} gives Alice the full secret information. Alice similarly sends her encoded secret information or secret key, I_{A} to Bob and the procedure repeats.

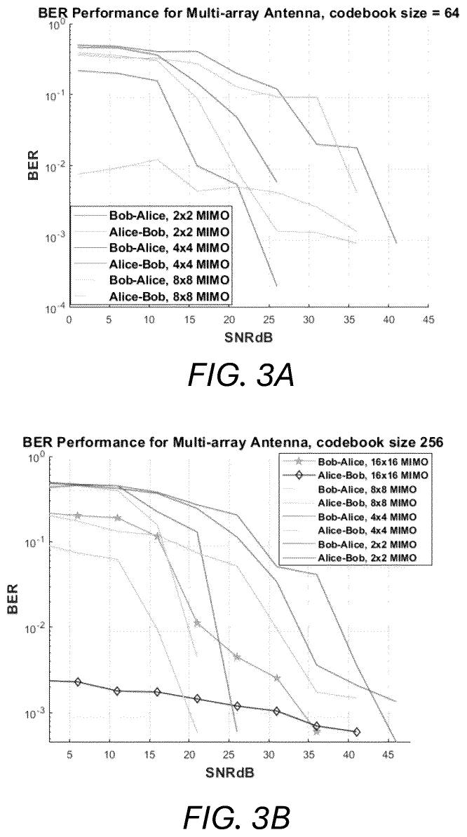

FIG. 3 shows security performance Bit Error Rate (BER) diagrams (BER before applying error correction codes) that illustrate that a shared key based PLS can transmit higher information bits with guaranteed security, as the larger codebook provides more secret bits and higher spectral efficiency.

In Stage 0, S₀, the legitimate transmitter, Alice, first sends out a reference signal for the legitimate receiver, Bob, to estimate the channel matrix H_{AB}, as illustrated in FIG. 1. In FIG. 2, transmission through the channels has been demonstrated where M pilot signals or reference signals, r_{M} are spread over M subchannels, where M is the number of antennas. Then random unitary matrix, G, is used to obscure the reference signal, r_{M}. Gr_{M} is sent to Bob at the end of this stage.

In Stage 1, S₁, Bob receives the signal. Bob performs SVD operation, which is demonstrated by equation:

$${H}_{AB} G = {U}_{B} {\sum }_{B} ( {V}_{B}^{′} G )$$

The reference signals in the received signals are omitted from the received signal equations as at the receiving end the receiver omits the reference signals by dividing them from the received signal. Bob has his own n-bit secret information, I_{B}. Bob divides I_{B} into

$$[ \frac{n}{p} ]$$

groups of p-bit sequences, where n is the secret key length. For each p-bit sequence, Bob finds the corresponding precoding matrix, F_{B}, whose index is equivalent to each of the sequences. Bob transmits G¹r_{M} to Alice, where G¹=U^{†}_{B}F^{†}_{B}. At the end of Stage 1, Alice receives the noisy information signals over the channel. Alice receives the noisy information signal and feeds the signal into the ML model to decode Bob's secret information. From the ML model, Alice obtains the corresponding precoding matrix index (PMI) of Bob's encoded secret information as model output, and thus estimates Bob's secret information, I\hat{ }_{B}. The full secret information at Alice's end by the end of Stage 1 is a concatenation of I_{A} and I\hat{ }_{B}.

In stage 2, Alice has her own secret information and she wants Bob to receive and decode it. Similar to Stage 1, in Stage 2, S₂, Alice generates her own n-bit random secret information, I_{A}. Alice divides I_{A} into

$$[ \frac{n}{p} ]$$

groups of p-bit sequences, where n is the secret key length. For each p-bit sequence, Alice finds the corresponding precoding matrix, F_{A} whose index is equivalent to each of the sequences. Alice transmits G²r_{M} to Bob, where G²=V_{A}F^{†}_{A}. Bob inputs the noisy received information into the ML model. The AI/ML model takes the noisy signal information as input, and Bob obtains estimated version of Alice's n-bit random signal information, I\hat{ }_{A}, from the model output similar to Stage 1. The full secret information at Alice's end by the end of Stage 1 is a concatenation of I_{B} and I\hat{ }_{A}.

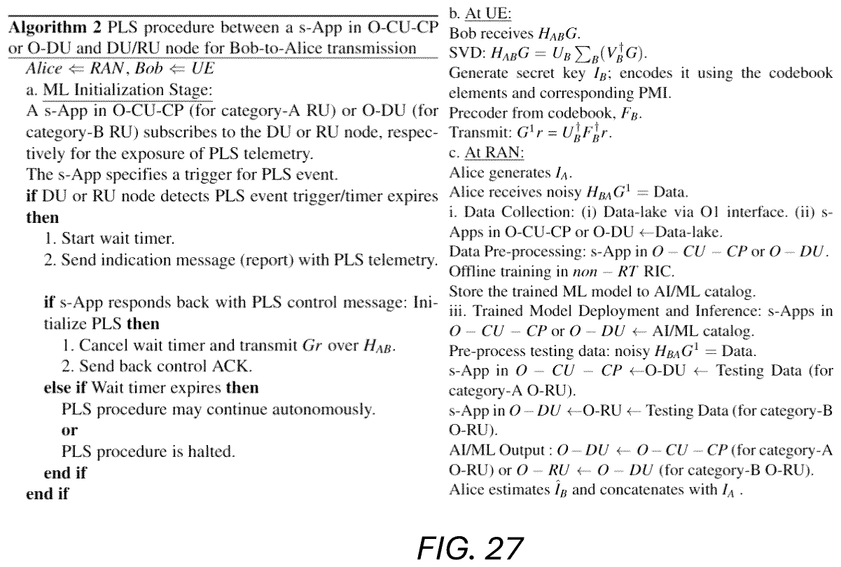

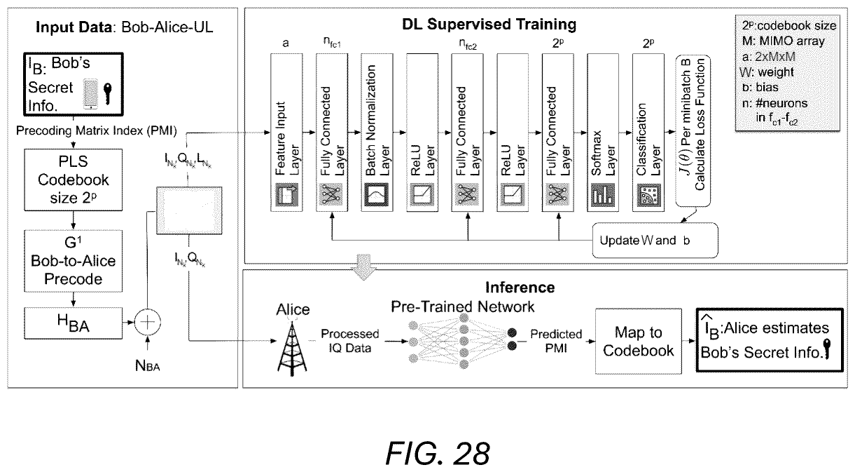

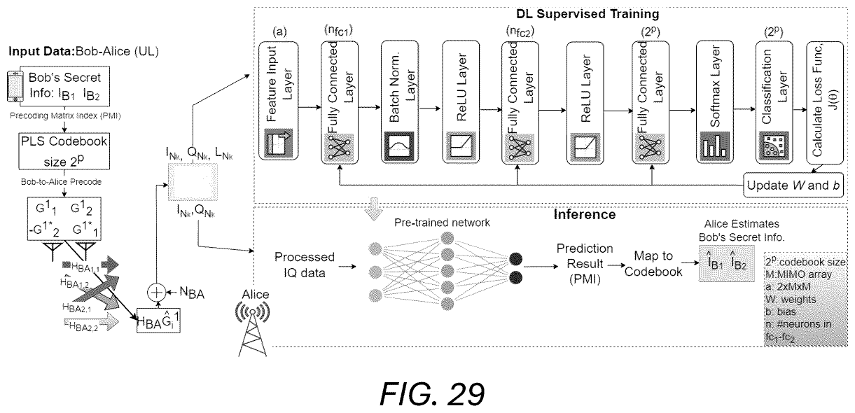

AI and machine learning tools have been utilized to improve this process. FIG. 27 is an illustration of an exemplary embodiment of an AI/ML-based Physical Layer Security procedure in O-RAN according to the teachings of the present disclosure. FIG. 28 is an illustration of an exemplary embodiment of the adopted ML model (Deep Neural Network) for decoding stage in Physical Layer Security procedure according to the teachings of the present disclosure. FIG. 29 is an illustration of an exemplary embodiment of ML-based decoding algorithm for space-time coded shared key-based PLS (Stage 1: Bob-to-Alice transmission) according to the teachings of the present disclosure.

The adopted machine learning model for decoding secret key at the receiver end is Deep Neural Network (DNN). The flowgraph of the proposed decoding method using DNN is shown in FIG. 28, where the input data is considered as IQ format. The received data corresponds to HGⁱ. The wireless channel state information H can be H_{AB} or H_{BA} depending on the channel in Stage 1 or 2. Superscript i refers to stages i=1 or i=2. I, Q, and H are complex in nature, the real and imaginary components (IQ) of the raw data is taken as input as shown in FIG. 28. If x=HGⁱ, then

$$\begin{matrix}I = real ( x ) \\ Q = imag ( x )\end{matrix}$$

where, real(•) and imag(•) represents the extraction of the real and imaginary components from the received signal x. The secret information is encoded using a codebook entry, and the corresponding PMI of the codebook entry is used as labels. Hence, for Nₖ number of secret information sequences or encoded secret keys, the training set is constructed such that:

$$𝒟 = [ \begin{matrix}I ( 1 ) & Q ( 1 ) & L ( 1 ) \\ I ( 2 ) & Q ( 2 ) & L ( 2 ) \\ . & . & . \\ . & . & . \\ I ( {N}_{k} ) & Q ( {N}_{k} ) & L ( {N}_{k} )\end{matrix} ]$$

A basic DNN works such as,

$${y}_{\text{?}} = {ψ}_{\text{?}} ( {z}_{\text{?}} )$$

$$z = {\sum }_{k = 1}^{\text{?}} {Wx}_{i} + {b}_{i} ,$$

$$\text{?} \text{indicates text missing or illegible when filed}$$

where, y_{predicted} is the predicted output and x is the input, W and b are the weights and biases of neurons in the DNN, ψ is the activation function, iₚ is the number of inputs from the incoming layer.

From FIG. 28, the DNN consists of input layer, fully connected layers, batch-normalization layer, activation layers: (i) Rectified Linear Unit (ReLU) layer, and (ii) Softmax layer and eventually, the classification layer as the output layer. The input layer inputs feature data I and Q to the neural network and the number of the inputs into this layer is a=2×M×M. The fully connected layer multiplies the input by a weight matrix and then adds a bias vector. n_{fc1} is the number of neurons for fully connected layer 1, n_{fc2} is the number of neurons for fully connected layer 2. The output size of fully connected layer 3 needs to match the number of classes (labels) in the dataset, hence it is 2^{p}. The batch normalization layer normalizes the mini-batch of data across all observations independently. Two activation layers were used in this model: The ReLU layer, which performs a threshold operation to each element of the input, where any value less than zero is set to zero. Two ReLU layers were positioned with a fully connected layer in between. The Softmax layer applies a softmax function to the input. It transforms the output into a probability distribution with positive values and a sum of “1”. The output layer is the classification layer. This layer outputs predicted labels based on the input data. Then a loss function is computed (for this DNN model, the loss function is cross-entropy loss). To minimize the loss function, the weights and biases are updated during the training process.

For multiple SNR case scenarios, noisy received signal (x=HGⁱ) is collected for respective Stages of transmission. The data is pre-processed as shown in previous section (in the format of D as shown before). The data collected was split into 70%-30% for training and validation purpose. Using the training data, the DNN model is trained for maximum epochs of 40. For each epoch, once training finishes, the validation data is randomly grouped into minibatch and loss function is computed, depending on which, weights and biases are updated to minimize the loss function. Some other parameters for DNN model training are: Minibatch size B=64, learning rate α=0.01, max epochs=40, maximum iterations λ=280, optimizer=SGDM, Shuffle=every-epoch.

After the model training is completed, in the inference stage, real-time received information signal with noise is being fed to the pre-trained DNN model as input in the corresponding form and the class with the highest confidence output is used as the PMI estimation result. Next, using the index, Alice or Bob, depending on transmission stage, can estimate each other's secret information, I\hat{ }_{B} or I\hat{ }_{A}. The full secret information is concatenation of estimated secret information and the receiver's own secret information.

Multipath fading in wireless channels is crucial to the underlying communication performance. Antenna diversity mitigates the effects of multipath fading. Space-time code (STC) or Space-frequency code (SFC) employs diversity techniques to improve reception quality and performance in wireless communications significantly. The present disclosure describes shared key PLS using Alamouti-based diversity coding. Introducing transmit and receive antenna diversity has proven to result in better error performance due to additional array gain. The Alamouti Space Time Coding (STC), and also Space Frequency Coding (SFC) are well-known diversity techniques used to spread the information at the transmitter end. Alamouti's technique has the advantages of: a) requiring Channel State Information at the Receiver (CSIR) only; b) relatively low computational complexity. Effects of passive eavesdropping can be significantly eliminated by adopting shared secret key schemes.

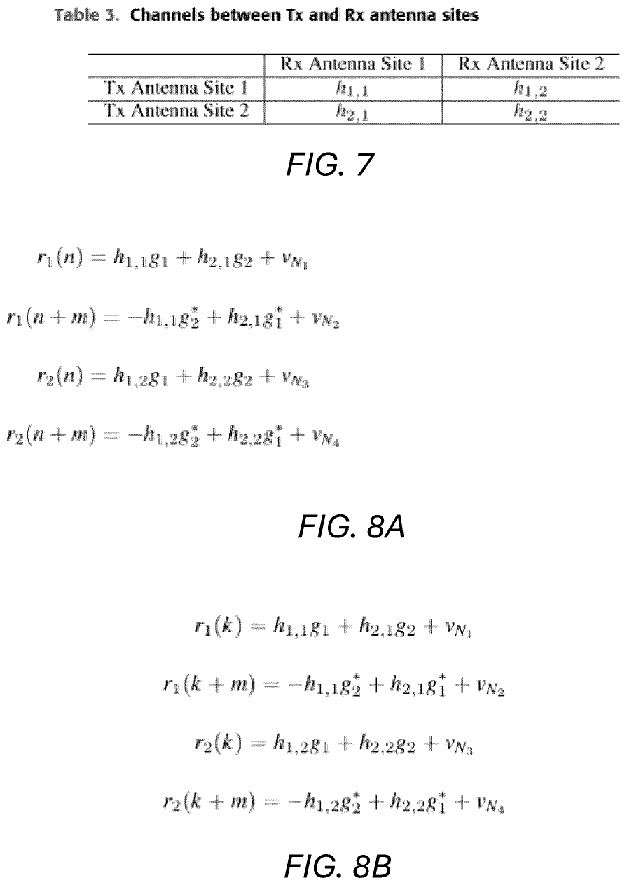

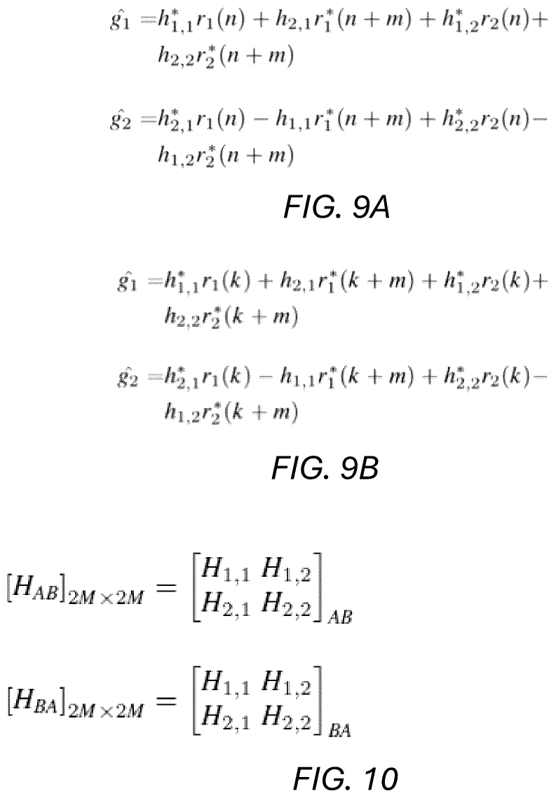

In a 2×2 Alamouti-based STC (or SFC), at a given symbol period (or frequency sub-channel), two signals are simultaneously transmitted from the two antennas. The signal transmitted from antenna 1 and antenna 2 are denoted by g1 and g2. During the next symbol period (or nearly adjacent sub-channel) signal (−g*₂) is transmitted from antenna 1, and signal g*₁ is transmitted from antenna 2, where * is the complex conjugate operation. The definition of channels between transmit and receive antenna sites is illustrated in FIG. 7. When space and time diversity at discrete time n and n+m (e.g., m=1) is applied, where continuous time, t=nT, and space and frequency diversity at frequency k δ and kδ+mδ, (δ is the subchannel spacing) e.g., m=−1, or m=1) where m could be any positive or negative frequency offset and m+k is close to k, at the receiving end the received symbols can be defined in the equations shown in FIG. 8. Parameters v_{N0}, v_{N1}, v_{N2}, and v_{N3} represent complex random variables representing receiver thermal noise and interference. Then a combiner builds the following two signals represented in equations in FIG. 9. An Alamouti-based STC (or SFC) then uses maximum likelihood decoders at the receiving end.

The focus of this disclosure is the application of the Alamouti STC (or SFC) in the time domain (over two adjacent time periods) or in the frequency domain (over two nearly adjacent frequency sub-channels) in a shared key-based PLS scheme with two transmit and receive antennas. The working procedure is defined by three functions: (i) Encoding the information matrices using a codebook, (ii) STC (or SFC) based on Alamouti scheme provides transmit and receive diversity, (iii) a decoding scheme to decode the secret information perfectly at the receiver end. The principal difference between the proposed framework and the conventional STC (or SFC) is that in the proposed framework, the transmitter and receiver are working with complex matrices instead of simple symbols as channel, information signal (secret key), and noise.

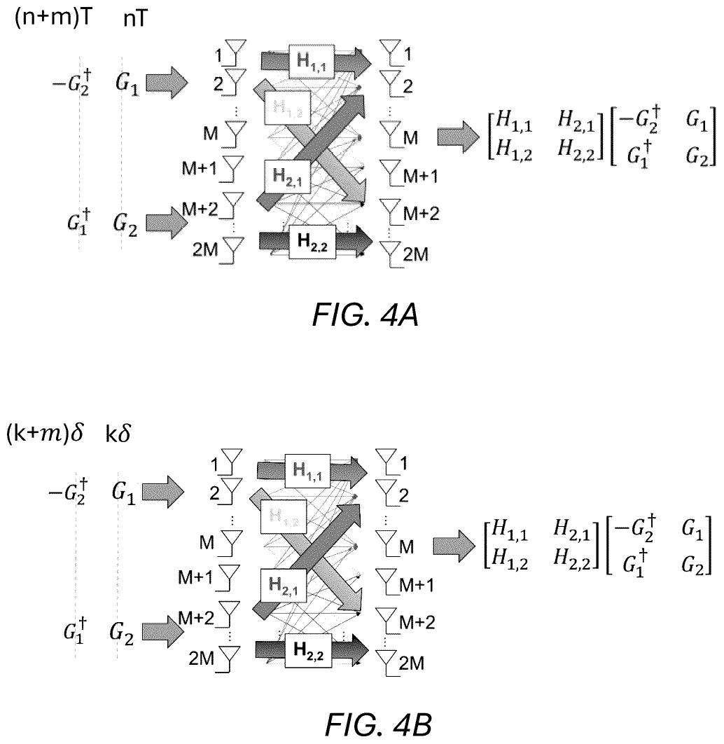

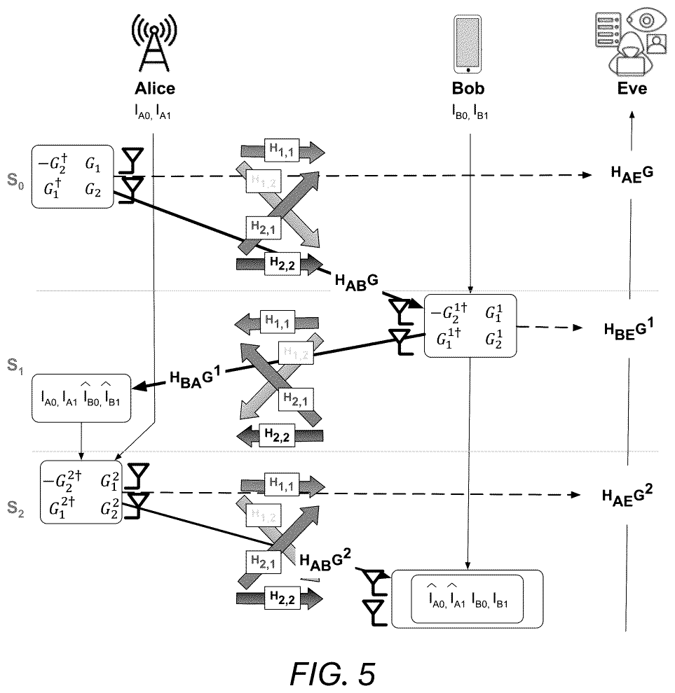

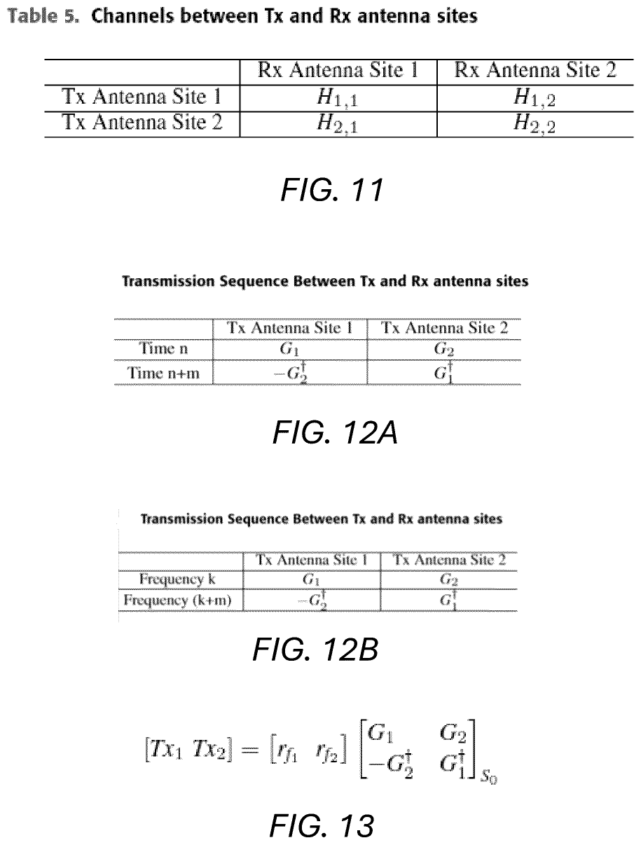

As illustrated in FIG. 4a, for STC, within a given time period, denoted by n, two 2-D information signals, G₁∈C^{M×M} and G₂∈C^{M×M} are transmitted from transmission antenna site 1 and transmission antenna site 2, respectively. In the next time period, denoted as n+m (e.g., m=1), the complex conjugates of the transmitted signals, represented as −G₂^{†} and G₁^{†} are transmitted respectively. As illustrated in FIG. 4b, for SFC, G₁ and G₂ can be transmitted in frequency subchannel kδ and their conjugates in frequency sub-channel (k+m)δ, similarly, where m=−1, or m=1) where m could be any positive or negative frequency offset (e.g., m=−1 or m=1) and m+k is close to k. The application of space-time diversity (or space-frequency diversity) contributes to greater channel capacity as the scheme enables the transmission of two concurrent signals. The channel super-matrices for Alice and Bob respectively, [H_{AB}] and [H_{BA}], can be defined as shown in FIG. 10, where each H_{1,1}, H_{1,2}, H_{2,1}, H_{2,2}∈C^{M×M} such that the definition of channels between transmit and receive antenna site is illustrated in FIG. 11. In this model, G₁ and G₂ can be any random unitary signal based on the transmission stage. In FIG. 5, the STC (or SFC) shared key-based PLS scheme operates in Stages 0-2 (S₀-S₂) described below.

Stage 0: PLS Initialization for Alice-to-Bob (Downlink) Channel: In Stage 0, S₀, the channel H represents the Alice-to-Bob (DL) channel, H_{AB}. In STC-based (or SFC based) PLS using two antenna sites and subsequent time periods, in case of STC (or nearly adjacent frequency sub-channels in case of SFC), twice the amount of secret information can be shared compared to the conventional shared secret key PLS model. In this model, to initialize PLS, Alice needs to follow two steps described below.

(i) First step: Alice and Bob transmit a pre-agreed-upon pilot signal to each other to estimate the channels, as illustrated in FIG. 2. In FIG. 2, transmission through the channels has been demonstrated where M pilot signals or reference signals, r_{M} (depending on transmission Stage 0 (i) or (ii)), are spread over M subchannels, where M is the number of antennas. The G, illustrated in FIG. 2 can be an identity matrix provided the transmission case scenario is in Stage 0, first step (i), or G can be any random unitary operator (G₁ or G₂) while transmitting in Stage 0, second step (ii), which is described below and is transmitted in subsequent time periods (or subchannels) as illustrated in FIGS. 12(a) and (b). The fundamental assumption is that due to coherent time, n and n+m (e.g., m=1) do not differ significantly. For Space-Frequency Coding, if the channel is frequency selective, channel coefficients of neighboring sub-channels might differ. Hence, channel residuals can be computed between adjacent sub-channels and adopt only those where channel residual is comparatively smaller and almost negligible. Once the pilot signals have been received, the receiver (Bob or Alice) can perform singular value decomposition (SVD) and reconstruct the channels, H_{1,1}, H_{1,2}, H_{2,1}, H_{2,2} from it and observe H.

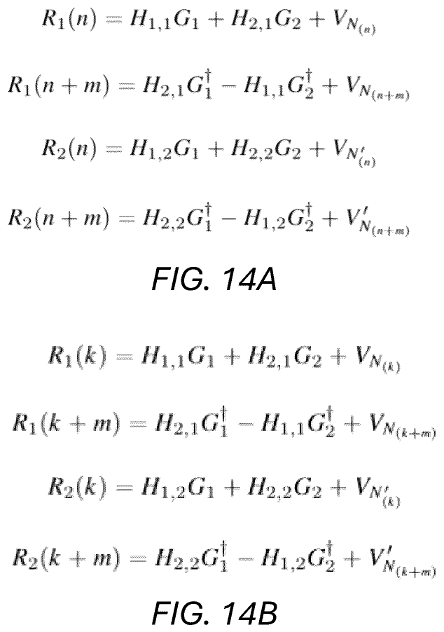

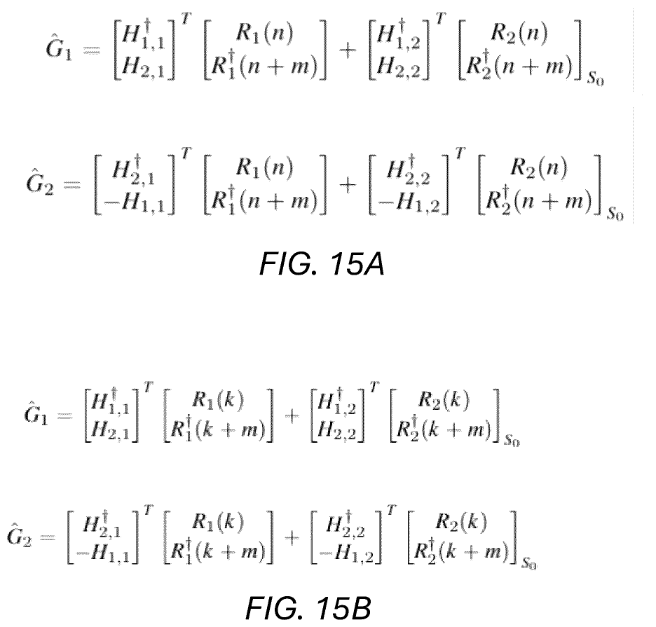

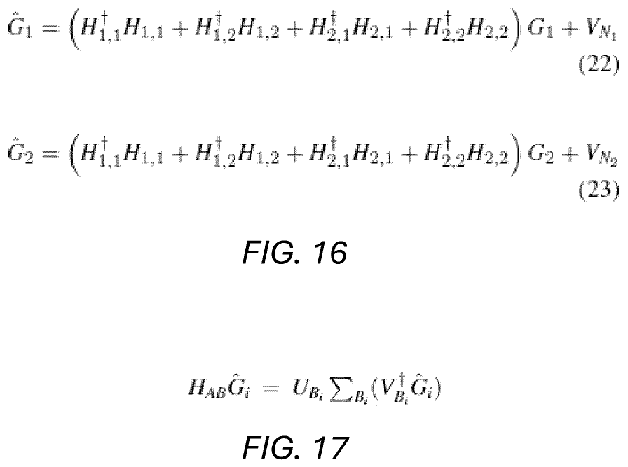

Second step (ii), Alice transmits two rotated reference signals, Gira where i=1, 2 in transmit antenna site 1 and in transmit antenna site 2 in time n and their complex conjugates are being transmitted in the next time instance at n+m (e.g., m=1), as illustrated in FIG. 4a, using the equations shown in FIG. 13. The same operation can be one for SFC for frequency subchannel (k)δ and (m+k)δ, (e.g., m=−1, or m=1) as illustrated in FIG. 4b. In the second step of Stage 0, G₁ and G₂ are the two random unitary operators of size M×M, and the reference signals [r_{f1} r_{f2}] are such that, r_{f1}∈C^{M×1}, where i=1, 2. The reference signals are used to send the random unitary signals through the subchannels, and at the receiving end the receiver omits the reference signals by dividing them from the received signal. The reference signals in the received signals are omitted from the equations shown in FIGS. 14a (in case of STC) and 14b (in case of SFC). The recombined received signals in two adjacent time periods n and n+m (e.g., m=1) in case of STC (or nearly adjacent frequency sub-channels (k)δ and (m+k)δ, (e.g., m=−1, or m=1) in case of SFC) are shown in FIGS. 15a and 15b for STC and SFC respectively. The noise matrix is shown as V_{N}∈C^{M×M}. Upon simplification, the equations for [symbol] and [symbol] can be presented as shown in FIG. 16. By the end of Stage 0, Bob will have, [symbol] and [symbol] , as shown in FIG. 16, which will be processed in Stage 1.

Stage 1: Bob-to-Alice (Uplink): In Stage 1, S₁, the channel H represents the Bob-to-Alice (UL) channel, H_{BA}. Bob performs the singular value decomposition (SVD) shown in FIG. 17, where i=1, 2. As two antenna sites are used, Ĝᵢ corresponds to [symbol] and [symbol] . In this approach, Bob can transmit two sets of secret information, I_{Bi}=(I_{B1}, I_{B2}). Bob divides I_{Bi} into

$$[ \frac{n}{p} ]$$

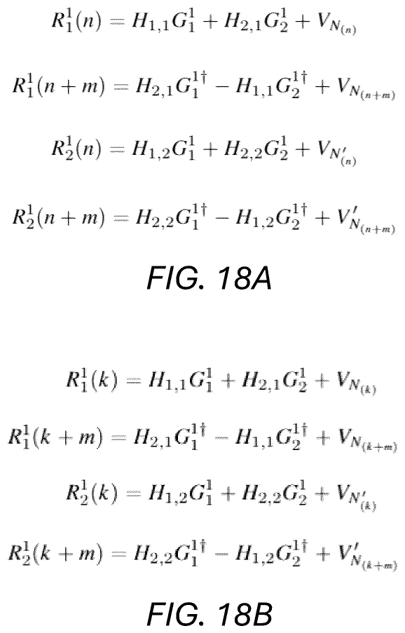

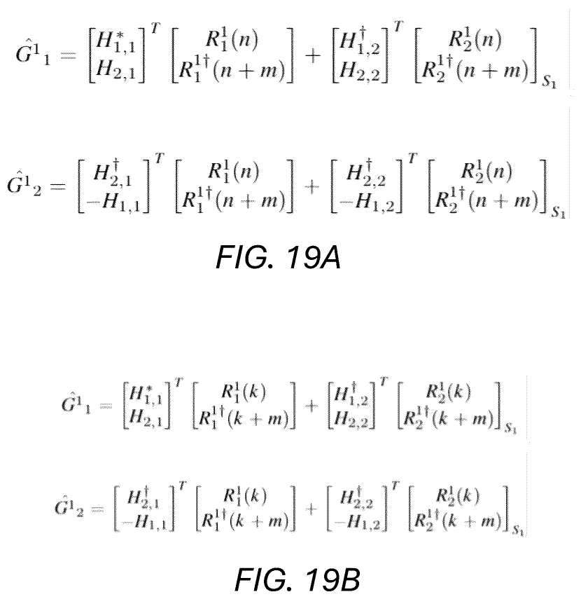

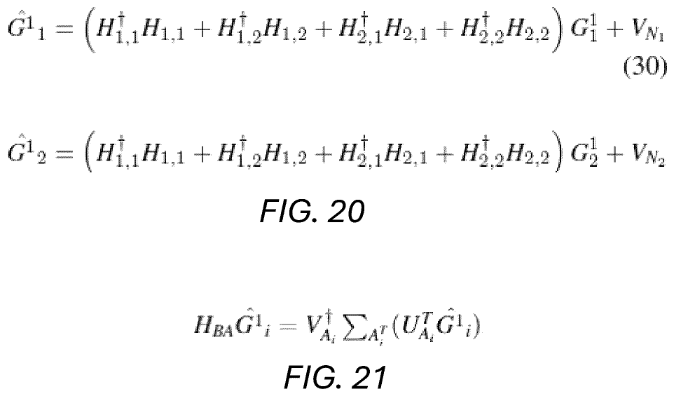

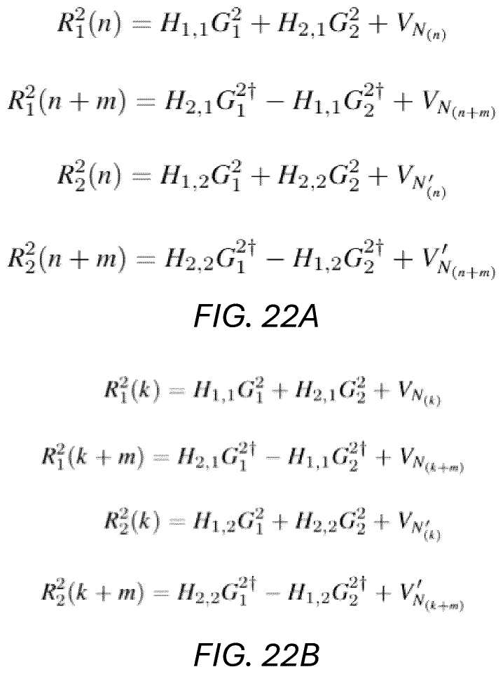

groups of p-bit sequences, where n is the secret key length. For each p-bit sequence, Bob finds the corresponding precoding matrix, F_{Bi}, with the equivalent index from the codebook and using the STC model, Bob transmits G¹ᵢr_{fi} to Alice, where G¹i=U^{†}_{Bi}F^{†}_{Bi}. At the end of Stage 1, Alice receives the noisy information signals over the channel which can be represented as shown in FIGS. 18a (for STC) and 18b (for SFC), where the superscript in G₁ and G₂ refers to the stage of transmission. At Alice's end in Stage 1, after the combiner, the simplified received signals are shown in FIG. 20. Alice estimates H_{BA}

as shown in FIG. 21, by performing SVD. After performing SVD, Alice also looks up the correct singular matrix in the codebook and estimates the Precoding Matrix Index (PMI) for both

$$and$$

and thus estimates I\hat{ }_{Bi}. The full secret information at Alice's end by the end of Stage 2 is a concatenation of I_{Ai} and I\hat{ }_{Bi}.

Stage 2: Alice-to-Bob (Downlink): In Stage 2, S₂, the channel H represents the Alice-to-Bob (DL) channel, H_{AB}. Alice transmits G²ᵢr_{fi} to Bob, where G²ᵢ=V_{A}iF^{†}_{Ai}. Bob estimates H_{AB}

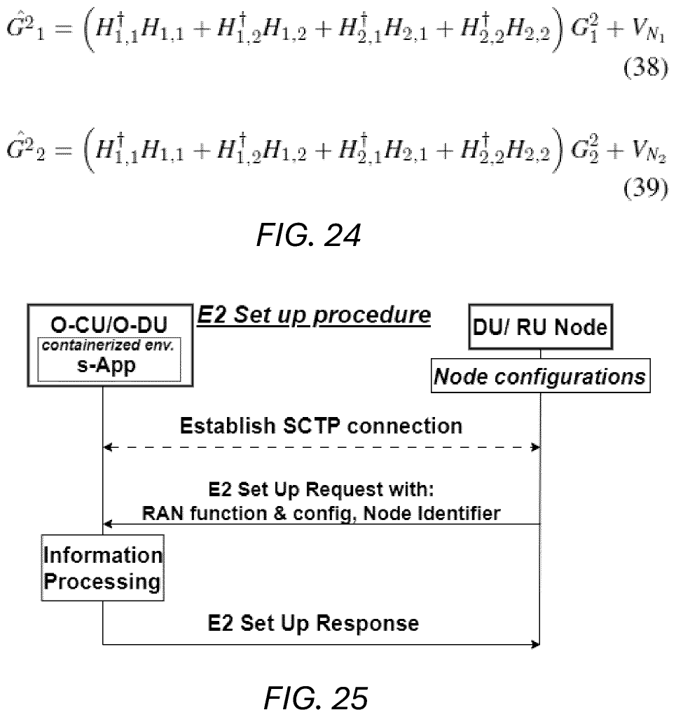

by performing SVD for the received, recombined and simplified signals as shown in FIG. 24, which are simplified versions of the equations for

$$and$$

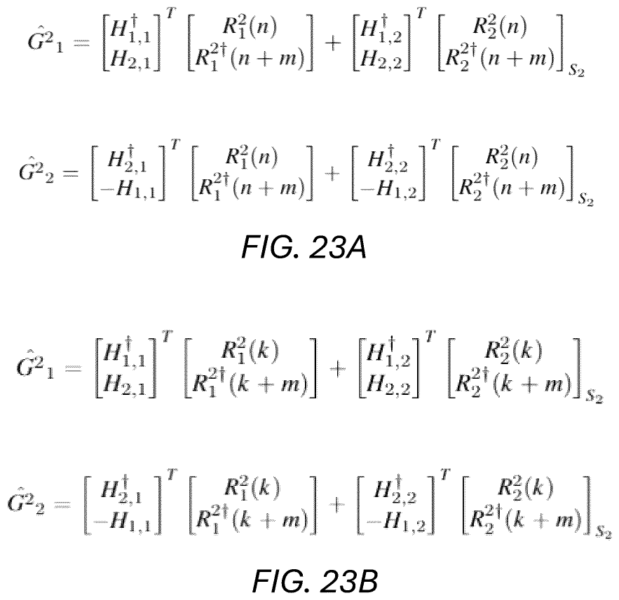

shown in FIG. 23a (for STC) and FIG. 23b (for SFC). At the end of Stage 2, Bob looks up the correct singular matrix in the codebook and estimates the PMI. Bob then obtains an estimated version of Alice's secret key which is denoted as [symbol] where [symbol] = [symbol] and [symbol] . The secret information of the entire system is the concatenation of [symbol] and I_{Bi}. Both Alice and Bob have half of the information that they calculated themselves and the other half is estimated in the form of the PMIs.

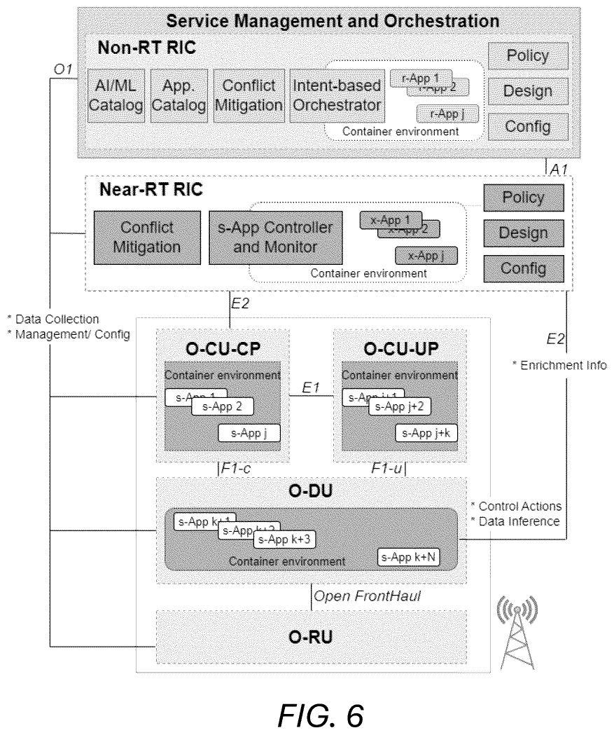

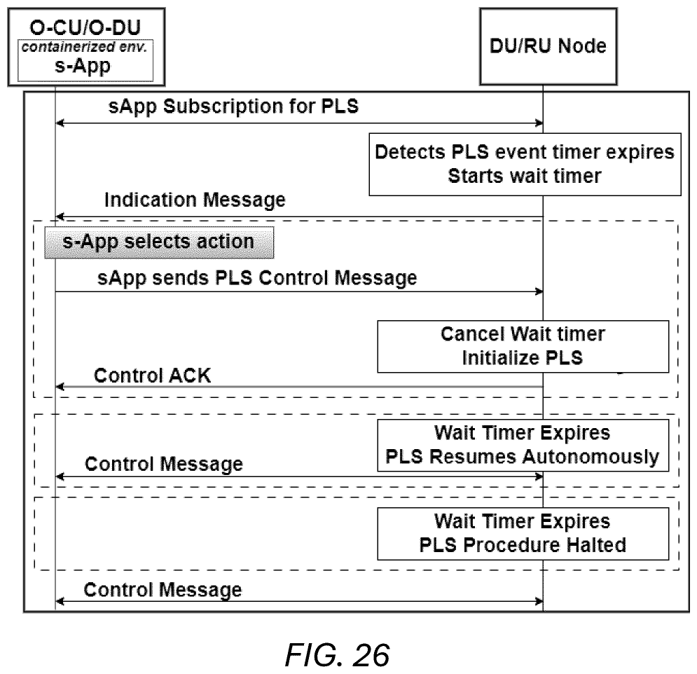

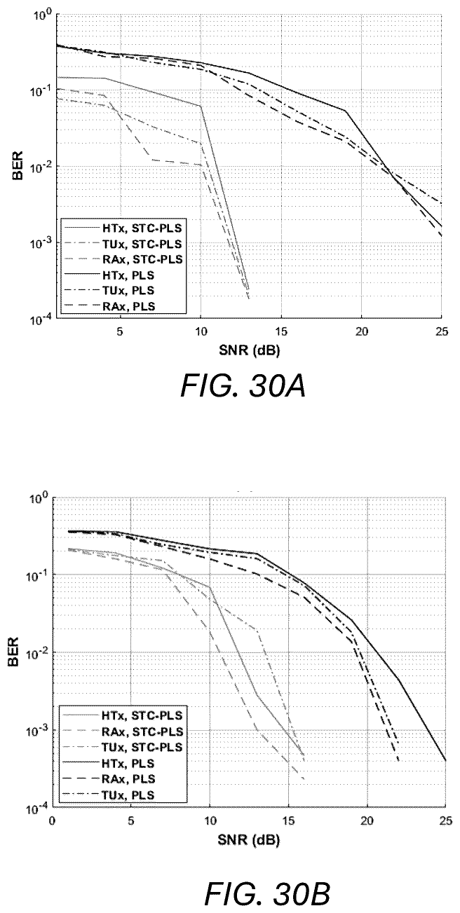

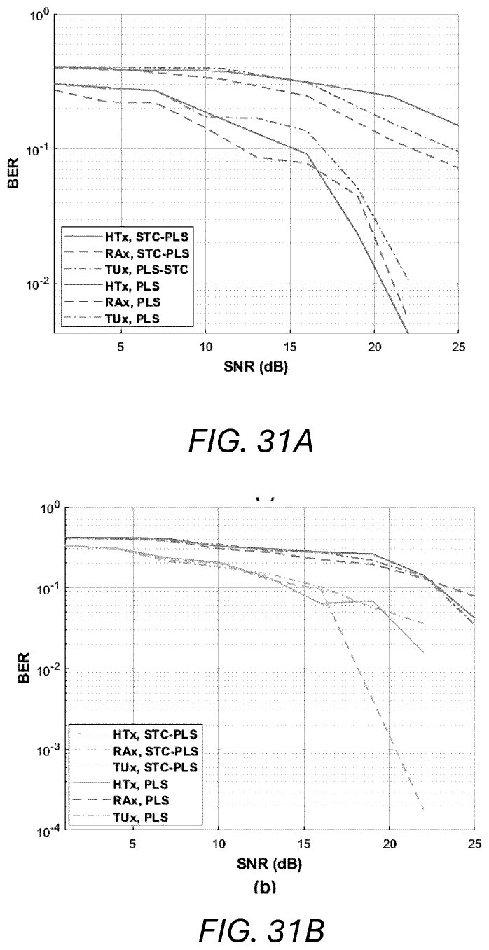

FIGS. 30(a) and (b) illustrate raw Bit Error Rate (BER), before applying error correction codes, versus SNR performance for non-STC shared key-based PLS and STC shared key-based PLS, using a 2-bit codebook in COST 259 fading channel environments for (a) uplink and (b) downlink transmission. The environments assessed are Typical urban (TUx), Rural Area (RAx) and Hilly Terrain (HTx) channels. Similarly, FIGS. 31(a) and (b) illustrates raw Bit Error Rate (before applying error correction codes) versus SNR performance for non-STC shared key-based PLS and STC shared key-based PLS, using a 4-bit codebook in COST 259 fading channel environments for (a) uplink and (b) downlink transmission. For all codebook sizes and uplink and downlink transmission cases, BER is significantly lower for a STC-PLS model than that of the non-STC PLS model. The results indicate that STC-based PLS can significantly contribute to ultra reliable security. FIG. 6 is a block diagram of a distributed Open Radio Access Network or O-RAN architecture that follows the “7-2x” functional option split. O-RAN is designed to improve interoperability so that one vendor's radio can be used with another's network code. The main objective of O-RAN is to enhance the RAN performance through virtualized network elements that will also reduce component and deployment cost, and open interfaces that incorporate intelligence in RAN. According to the 3GPP definition in release 15, RAN is logically split into three entities denoted as O-CU (Open Centralized Unit), O-DU (Open Distributed Unit), and O-RU (Open Radio Unit), as shown in FIG. 6. An O-RU is used to convert radio signals sent to and from the antenna into a digital baseband signal, which can be connected to the O-DU over the O-RAN split “7-2x” fronthaul interface. It logically hosts radio frequency (RF) processing and the low-PHY layer consists of the D/A conversion, cyclic prefix, and IFFT insertion. The O-DU is a logical node which is responsible for MAC/RLC and High-PHY processing. The interface between O-DU and O-RU is known as Open Fronthaul (O-FH) interface. The O-CU runs SDAP/RRC and PDCP layers. The F1 interface has been standardized for communication between the O-CU and O-DU. To ensure Secure Ultra-Reliable Low-Latency Communications (SURLLC) in 6G, the control decisions and execution need to be realized in real time. The additional communication results in increased latency and overhead over the E2 interface to support data collection, inference, and control. To mitigate this challenge, the notion of dApps is introduced, which are custom and distributed applications that complement x-Apps/r-Apps by implementing RAN intelligence at the CUs/DUs for real-time use cases outside the timescales of the current Ran Intelligent Controllers (RICs). The concept of dApps can be adapted to ‘security Apps’ or ‘s-Apps’ in order to implement low latency security scheme for operating in the lower layer of protocol stack and extended it to propose a functional integration and working procedure overview for the use case of PLS. The s-Apps are containerized micro-applications used for exchanging low latency information securely between the UE and O-RAN network over physical layer security channels. The proposed PLS scheme uses suitable ORAN interfaces like E2 interface. The E2 set up procedure and E2 Service Mode (SM) are extended to the s-Apps as shown in FIGS. 25 and 26. The E2 set-up procedure occurs in conjunction with near-RT RIC. The s-Apps can receive enforcement information from near-RT RIC via the E2 interface, acting as the northbound interface. The addition of s-Apps requires a manager or orchestrator. The orchestrator needs to manage which applications should be executed and where. An intent-based orchestrator is located in SMO and performs the responsibility. The orchestrator can operate either as a r-App or as a standalone component. It gathers all the requests of the operator in a tupple, accesses AI/ML catalog for an initial ML model and determines optimal policy that would ascertain which requests to accommodate, which ML model to choose and where should they be executed. Depending on the optimal policy, containers (s-App or x-App) are created in the form of O-RAN applications with embedded AI/ML model. These applications reside in application catalog inside non-RT RIC and is dispatched to RAN location (DU, CU or RICs) to be executed depending on the operator's requirement. The intent needs to be specified by the operator. The near-RT RIC hosts an s-App controller and monitor to mitigate potential conflict of interest between s-Apps and x-Apps. The RAN and RIC communicate via O1 interface between each other. The near-RT RIC and non-RT communicate via A1 interface.

For the invention, the containerized micro-application, s-App resides in O-CU or O-DU, based on category A or category B O-RU used, respectively. In that environment the s-App controls precoding application residing in O-DU or O-RU, respectively.

To initiate 6G PLS, the first step is ML Initiation Stage by Alice (RAN), who will send a rotated reference signal, Gr, to Bob (UE). This step takes place in an s-App located in the E2 node (O-DU or O-CU). The E2 set up procedure is illustrated in FIG. 25. E2 interface runs on top of the SCTP protocol. As shown in FIG. 25, the O-DU (in case of category A O-RU) or the O-RU (in case of category B O-RU), transmits an E2 set up request that lists the RAN functions and configurations, and the node identifier. The sApp in CU or DU node processes this information and replies with an E2 set up response.

After the connection is established, an E2 Service Model RAN Controller implements the 6G PLS protocol. To send the rotated reference signal to Bob (UE) in this stage, Alice (RAN) publishes data to the s-App to initialize the PLS procedures. The PLS control service message exchange between the s-App and the DU or RU node is shown in FIG. 26. For transmission downlink, the O-DU node for category A O-RU computes scrambling, modulation, layer mapping, PLS precoding, RE mapping and eventually sends Gᵣ to Bob (UE). If category B O-RU is used, the O-RU node computes PLS precoding and beamforming, IFFT and CP addition, D/A conversion and eventually sends Gᵣ to Bob (UE). After receiving the reference signal, Bob initiates the next transmission stage. For Stage 1: Uplink transmission, Bob sends his encoded secret key to Alice.

Alice receives Bob's secret information and decodes and estimates I_{B}. Traditionally, the AI/ML training data collected in SMO applies training protocols in x-Apps of the Near-RT RIC. The AI/ML training procedure can occur in containerized micro-application, s-Apps in the O-DU (for category B O-RU) or O-CU-CP can host micro-application s-App and the precoding operation can occur in O-DU (for category A O-RU), which will alleviate significant latency by obtaining data locally. The proposed AI/ML life cycle with s-Apps consists of following steps which follow guideline provided by the O-RAN Alliance:

(i) First, data collection occurs over the O1 interface from O-RU and O-DU and a data-lake stores the resulting information. The data lake represents a centralized repository designed to store, process, and secure large amounts of structured, semi-structured, and unstructured data. After data collection campaigns have occurred over the range of SNR values and CSI environment scenarios, the containerized micro-application s-App data-processing unit within O-CU-CP (for category A O-RU), or O-DU (for category B O-RU) pre-processes IQ data and format requests.

Model training within the O-RAN specifications require each AI/ML models support offline training. Due to large pool of compute and storage resource requirement, the non-RT RIC typically hosts initial training. Upon AI/ML model training (or retraining) and validation, results are stored in an AI/ML catalog. However, to fine tune and update an already trained model, online training can occur too. Pre-processed data trained inside a containerized micro-application, s-App in O-CU-CP (for category A O-RU), or O-DU (for category B O-RU) allows s-App fine-tuning. The online model tuning allows adaptation to time-varying wireless channel states.

ML Model Deployment occurs after the AI/ML model has been trained and validated. The model is stored in an AI/ML catalog. Based on optimal policy determined by the orchestrator, the pre-trained ML model previously stored in the AI/ML catalog can be downloaded, deployed and executed as a containerized image in the form of an O-RAN application. Thus, the s-App in the O-CU-CP (for category A O-RU), or O-DU (for category B O-RU) over the O1 interface represents the Inference Host.

AI/ML Execution and Inference models, once deployed, serve as the Inference Host. At run-time, the containerized micro-application, s-App communicates with the O-DU/O-RU for real-time data. The containerized s-App within O-CU-CP (for category A O-RU), or O-DU (for category B O-RU) first subscribes to the O-DU or O-RU respectively, by sending it a Subscription message. As periodic reports are triggered, the reports are sent through Indication messages, and the data is pre-processed into IQ format in a data driven logic unit used for testing. The processed data is fed to the ML model as input. The AI/ML output (in this case the PMI) is sent to O-DU and O-RU based on category A or category B O-RU used, as a form of PLS Control message via the Open Fronthaul. Eventually, Alice estimates I\hat{ }_{B}. By concatenating I\hat{ }_{B} and I_{A}, Alice now has the entire information.

The AI/ML lifecycle iterates. Thus, the integration of s-Apps further proposes realizing “AI at the edge” to significantly improve network performance and latency.

The present disclosure describes a method of achieving secure and reliable 6G communication technology with the integration of AI/ML and transmission diversity (Space-Time or Frequency Coding) in the Physical Layer Security scheme. This disclosure defines AI/ML and STC (or SFC) integration with shared key based PLS and provides an operational overview of this AI/ML procedure in the 6G O-RAN for application use cases. What is also proposed is a low latency solution for 6G O-RAN operation by implementing “s-Apps” to achieve ultra secure and low latency communication. This scheme focuses on protection against passive eavesdroppers that can also passively act as Meddler-in-the-Middle with the help of AI/ML and STC in PLS to achieve secure detection even at low SNR.

### Glossary

6G Sixth-Generation
AI/ML Artificial Intelligence/Machine Learning
BER Bit Error Rate
CSIR Channel State Information at Receiver
CU Centralized Unit
DL Downlink
DU Distributed Unit
ECC Error Correction Codes
eMBB-Plus Enhanced Mobile Broadband Plus
IoE Internet of Everything
ITU International Telecommunication Union
MIMO Multiple Input Multiple Output
O-CU Open Centralized Unit
O-CU-CP O-RAN Centralized Unit-Control Plane
O-CU-UP O-RAN Centralized Unit-User Plane
O-DU O-RAN Distributed Unit
O-RAN Open Radio Access Network
O-RU O-RAN Radio Unit
OSI Open System Interconnect
PHY Physical
PLS Physical Layer Security
PMI Precoding Matrix Index
RAN Radio Access Network
RIC RAN Intelligent Controller
S-App Security App
SNR Signal-to-Noise Ratio
STC Space-Time Coding
SURLLC Secure Ultra-Reliable Low-Latency Communications
SVD Singular Value Decomposition
TDD Time Division Duplex
UE User Equipment
UL Uplink
UTC Ultra Massive Machine Type Communication
X-App Independent software plug-in to the Near-Realtime RIC platform to provide functional extensibility to the RAN by third parties

The features of the present invention which are believed to be novel are set forth below with particularity in the appended claims. However, modifications, variations, and changes to the exemplary embodiments of the invention described above will be apparent to those skilled in the art, and the described herein thus encompasses such modifications, variations, and changes and are not limited to the specific embodiments described herein.

What is claimed is:

1. A computer-implemented Alamouti shared secret key physical layer security method between first and second network nodes in a communications network, comprising:
first network node transmitting a first pilot signal to a second network node via first M antenna elements;
second network node transmitting a second pilot signal to the first network node via second M antenna elements;
the second network node receiving, by the second M antenna elements, the pilot signal transmitted by the first network node via the first M antenna elements;
the first network node receiving, by the first M antenna elements, the pilot signal transmitted by the second network node via the second M antenna elements;
the first and second network nodes each performing singular value decomposition of the respective received pilot signals and reconstruct the channels between the first and second M antenna elements of the first and second network nodes;
the first network node transmitting, at time slot n or frequency subchannel k, two reference signals rotated by a random unitary matrix to the second network node via the first M antenna elements;
the first network node transmitting, at time slot n+m (e.g., m=1) or frequency sub-channel k+δ, complex conjugates of the two rotated reference signals to the second network node via the first M antenna elements;
the second network node receiving the signals transmitted by the first network node over the n and n+m time slots;
each of the first and second network nodes generating first and second secret keys, respectively;
the second network node dividing the second secret key into a plurality of sequences, encoding each plurality of second secret key sequence using a precoding matrix and corresponding index from a universal codebook, and transmitting the encoded second secret key sequences via the second M antenna elements to the first network node;
the first network node receiving, by the first M antenna elements, the transmitted encoded second secret key sequences from the second network node, and combining the encoded second secret key sequences received by the first M antenna elements;
the first network node performing singular value decomposition of the received combined encoded second secret key sequences, looking up the precoding matrix and estimating the corresponding index from the codebook, to estimate the second secret key;
the first network node concatenating the estimated second secret key with the first secret key to determine a whole secret key;
the first network node dividing the first secret key into a plurality of sequences, encoding each plurality of first secret key sequence using a precoding matrix and corresponding index from the universal codebook, and transmitting the encoded first secret key sequences via the first M antenna elements to the second network node;
the second network node receiving, by the second M antenna elements, the transmitted encoded first secret key sequences from the first network node, and combining the encoded first secret key sequences received by the second M antenna elements;
the second network node performing singular value decomposition of the received combined encoded first secret key sequences, looking up the precoding matrix and estimating the corresponding index from the codebook, to estimate the first secret key;
the second network node concatenating the estimated first secret key with the second secret key to determine the whole secret key; and
the first and second network nodes continuing to communicate therebetween using the whole secret key.

2. The computer-implemented method of claim 1, wherein the information processing in the first and second network nodes occur in respective security apps over Open Radio Access Network (O-RAN) E2 interfaces.

3. The computer-implemented method of claim 1, wherein the information processing in the first and second network nodes occur in respective security apps executing in an Open Radio Access Network (O-RAN) Centralized Unit or Distributed Unit over O-RAN E2 interfaces.

4. A communication network node configured to execute an Alamouti shared secret key physical layer security method, comprising:
M antenna elements;
a processor configured to:
transmit a first pilot signal to a second network node via first M antenna elements;
receive a second pilot signal from the second network node via the first M antenna elements;
perform singular value decomposition of the received second pilot signal and reconstruct the communication channels with second network node;
transmit, at time slot n or frequency sub-channel k, two reference signals rotated by a random unitary matrix to the second network node via the first M antenna elements;
transmit, at time slot n+m (e.g., m=1) or frequency sub-channel k+δ, complex conjugates of the two rotated reference signals to the second network node via the first M antenna elements;
generate a first secret key;
receive, by the first M antenna elements, encoded second secret key sequences from the second network node, and combine the encoded second secret key sequences received by the first M antenna elements;
perform singular value decomposition of the received combined encoded second secret key sequences, looking up the precoding matrix and estimating the corresponding index from the codebook, to estimate the second secret key;
concatenate the estimated second secret key with the first secret key to determine a whole secret key;
divide the first secret key into a plurality of sequences, encode each plurality of first secret key sequence using a precoding matrix and corresponding index from the universal codebook, and transmitting the encoded first secret key sequences via the first M antenna elements to the second network node; and
communicate with the second network node using the whole secret key.

5. The communication network node of claim 4, wherein the information processing in the network node occurs in a containerized micro-application, security app over Open Radio Access Network (O-RAN) E2 interfaces.

6. The communication network node of claim 4, wherein the network node is an Open Radio Access Network (O-RAN) Centralized Unit or Distributed Unit.

7. A method of implementing Alamouti shared secret key physical layer security method between first and second network nodes in a communications network, comprising:
sending, from the first network node, a signal including a reference signal to the second network node via first M antenna elements;
receiving, via a second M antenna elements of the second network node, the reference signal, and performing a singular value decomposition operation, removing the reference signal, and reconstructing the channel between the first and second M antenna elements of the first and second network nodes;
dividing, at the second network node, its secret key into a plurality of sequences, encoding each plurality of its secret key sequence using a precoding matrix and corresponding index from a universal codebook, and transmitting the encoded secret key sequences via the second M antenna elements to the first network node;
receiving, via the first M antenna elements of the first network node, the encoded secret key sequences;
providing, as input, the encoded secret key sequences to a machine learning model, and determining a precoding matrix index (PMI) as an output from the machine learning model;
using the PMI, and determining the secret key of the second network node;
dividing, at the first network node, its secret key into a plurality of sequences, encoding each plurality of its secret key sequence using a precoding matrix and corresponding index from a universal codebook, and transmitting the encoded secret key sequences via the first M antenna elements to the second network node;
receiving, via the second M antenna elements of the second network node, the encoded secret key sequences transmitted by the first M antenna elements;
providing as input, at the second network node, the received encoded secret key sequences to a machine learning model, and determining a PMI as an output from the machine learning model;
using the PMI, and determining the secret key of the first network node;
concatenating the first secret key with the second secret key to determine the whole secret key; and
continuing communicating between the first and second network nodes using the whole secret key.
